(19) United States
(12) Patent Application Publication
(10) Pub. No.: US 2015/0333899 A1
(43) Pub. Date: Nov. 19, 2015

(54) Synchronization Of Data Packets In A Data Communication System Of A Vehicle

(71) Applicant: CONTINENTAL AUTOMOTIVE GMBH, Hannover (DE)

(72) Inventors: Josef NÖBAUER, Neukirchen-Balbini (DE); Helge ZINNER, Magdeburg (DE)

(73) Assignee: Continental Automotive GmbH

(21) Appl. No.: 14/652,411

(22) PCT Filed: Dec. 2, 2013
(86) PCT No.: PCT/EP2013/075215

§ 371 Date: Jun. 15, 2015

(30) Foreign Application Priority Data
Dec. 14, 2012 (DE) 10 2012 223 307.5

(51) Int. Cl. H04L 7/00; H04L 12/66; H04L 12/40

(52) U.S. Cl. CPC H04L 7/0012; H04L 12/40; H04L 12/66; H04L 2012/40273

(57) ABSTRACT

Synchronizing data packets from an unclocked data communication network with a clocked data communication network includes: receiving clocked data packets in a gateway at clock cycles of the clocked network; packing data from the clocked data packets into first unclocked data packets for the unclocked data communication network in the gateway; providing the unclocked data packets with a time stamp, from which a clock cycle of a clocked data packet can be reconstructed; transmitting the first unclocked data packets via the unclocked network to a receiver node of the unclocked network; reading the time stamps out of the first unclocked data packets and reconstructing the clock cycle of the clocked network from the time stamps, a transmission frequency, a number of clocked data packets and/or a local clock in the receiver node; and transmitting second unclocked data packets in a clock cycle which is synchronous with the reconstructed clock cycle.

### FIELD OF THE INVENTION

The invention relates to a method for synchronizing data packages or applications and systems, respectively, from a free-running, an event-controlled, or non-time controlled data communication network with a clocked data communication network and to a data communication system for a vehicle.

### BACKGROUND OF THE INVENTION

Electronic systems of a vehicle can be divided into subsystems. For example, engine and transmission control are allocated to the power train, the electronic brake is allocated to the chassis area, and comfort functions such as airconditioning system are allocated to the body area.

Due to different requirements with regard to safety, bandwidth, response time, and costs, these subsystems, and the data communication networks associated with them such as special communication buses (CAN, LIN, MOST, FlexRay) are frequently strictly separated from one another.

As a rule, subsystem independent functions require the electronic subsystems to be networked beyond the subsystem boundaries; this can be implemented by one or more system interfaces or gateways.

Apart from typical communication bus systems from the automotive field, Ethernet can also be used in a vehicle. Ethernet, having a high bandwidth, a high degree of flexibility, and worldwide standardization will become an important system interface of an automobile and such a gateway control device in the next few years. However, Ethernet-based data communication networks are hitherto used only sporadically in motor vehicles.

Various gateway types can switch between the above-mentioned communication buses. However, the quality and temporal correlatability of the data is lost during the data transport or data exchange from one communication bus into the other with these types of gateways.

When transmitting MOST data to an Ethernet network, the demand may exist that the time intervals of the clocked or time-controlled bus system, such as MOST, should not be lost during the transport via the gateway. If, for example, data of an Ethernet network is fed into a MOST network, this may otherwise mean a high expenditure of memory and/or sample rate conversion, which can lead to a latency of the data transport, among other things. The consequence may be that the quality of the data degrades and, in the worst care, the data can no longer be utilized in the worst case.

For vehicle data communication systems, there are implementations that are called gateways which, among other things, are equipped for switching between a clocked and a free-running data communication network. However, the time interval information is lost in these implementations, i.e. although data which has been produced in a clocked data communication network are sent into a free-running data communication network and, the temporal synchronization of the data is lost during the process. A quality of service of data is not given by these implementations as soon the data leaves a clocked data communication network. For example, the correlation of data packages with fixed time markers should be retained. To evaluate the quality of service of data, it is possible to utilize parameters such as delay and jitter.

For free-running data communication networks, it is known to produce a common time base by PTP (Precision Time Protocol). Special embodiments of this are standardized, for example via IEEE1588, IEEE1588v2 and IEEE802.1AS. On the basis of this temporal synchronism, this time interval information is used in protocols such as IEEE1722 and IEEE1733 for providing the associated data with a fixed absolute time stamp in the data communication network.

The requirement for temporal synchronism in a free-running data communication network is known and there are, therefore, various methods for this purpose which, for example, have led to various real-time Ethernet variants. One special variant in this context is Ethernet AVB (Audio Video Bridging).

Ethernet/Ethernet AVB is currently not yet used as network technology in the vehicle but the MOST bus system is exclusively in this branch of the industry.

### SUMMARY OF THE INVENTION

It is an object of one embodiment of the invention to provide high-quality data between various data communication systems of a vehicle.

One aspect of the invention relates to a method for synchronizing data packages and a clock from a free-running data communication network with a clocked data communication network.

The clocked or time-controlled data communication network can be a MOST network. For example, MOST 150, i.e. the third generation of MOST, can be used as such a data communication network.

The free-running or non-time-controlled data communication network can be an Ethernet network. In this context, Ethernet AVB can be used as protocol.

According to one embodiment of the invention, the method comprises the steps of: receiving clocked data packages from the clocked data communication network in a gateway at time intervals of the clocked data communication network; packaging data from the clocked data packages into first free-running data packages for the free-running data communication network in the gateway; providing the free-running data packages with one time stamp in each case, from which a synchronized time interval of the free-running network can be reconstructed on the basis of the clocked network, the data of which had been packaged in a respective first free-running data package; sending the first free-running data packages via the free-running data communication network to a receiver node of the free-running data communication network; reading the time stamp and other protocol information from the first free-running data packages and reconstructing the time interval of the clocked data communication network from the time stamps, transmitting rate and number of packages in the receiver node; and sending second free-running data packages in a time interval which is synchronous with the reconstructed time interval.

For example, first data from MOST data packages can be sent to the receiver node via Ethernet. The receiver node then decodes the received Ethernet packages and reconstructs their time intervals. This means that a time interval regularly can have time intervals during which data packages are sent out.

If the receiver is to send second data into the MOST network, this data is then sent synchronized with the reconstructed time interval by the receiver node for first data which is in this case a transmitter node for second data. Data packages from these data can also be created synchronized with the reconstructed time interval in the receiver node. In this manner, the receiver node synchronizes the outgoing second data by the time interval of the received first data or data stream.

Using the method, the timing information from the clocked data communication network can be transferred into the free-running data communication network. This timing information can be utilized for sending data synchronously with the clocked data communication network from the free-running data communication network and to feed these data then synchronized again into the clocked data communication network. In this context, the free-running data communication network can operate so transparently that the quality of service of the time-controlled data is not falsified.

According to one embodiment of the invention, the problem of a data exchange between a free-running data communication network (such as, for instance, MOST) and an intrinsically free-running data communication network (such as, for instance, Ethernet according to IEEE 802.3) can be addressed by maintaining the temporal synchronism.

During a transmission period the MOST and Ethernet AVB network technologies can be used in parallel. Furthermore, there may be a requirement for migration scenarios from MOST to Ethernet. Using the method, these scenarios can be implemented without loss of quality of service (especially an audio/video quality) and without additional costly components such as additional memory or a sample rate converter, or a noticeable time delay.

All in all, different network technologies can be unified by means of the method. This can lead to a more cost-effective networking overall due to scale effects. A sample rate converter and a larger storage buffer for the data can be omitted. The quality of the data during transmission can be maintained. In addition, the possibility exists to work towards unifying the network technologies used, i.e. to replace existing networks progressively by a uniform network.

The gateway or the interface between the two data communication networks can be considered to be a QoS gateway that can switch between different clocked data communication networks and free-running data communication networks. The type of data exchange does not violate the quality of service of the respective transmitting data communication network (or of the data to be transmitted, respectively) during transportation into the other data communication network.

The time interval of the clocked data communication network can be a MOST time interval with 44.1 kHz or 48 kHz, for example, in the case of an MOST network. This time interval can be transmitted to the receiver node via a suitable transport protocol. In this process, the time interval is recovered in the receiver node and is thus available to various services. Data from the MOST network can thus be reproduced in the Ethernet network synchronously with the MOST network. Furthermore, it is possible to operate applications running on the Ethernet-based receiver node with this time interval and to feed their data into the MOST network via a suitable transport protocol via the gateway. Since the original time interval of this application or of the data transported can be attributed to the MOST network and is synchronous to the latter, the data can be used in the MOST network without loss of QoS.

According to one embodiment of the invention, the method also comprises synchronizing a clock generator of the gateway and a clock generator of the receiver node via the free-running data communication network. In order to transmit, for example, messages between MOST and Ethernet AVB while retaining the quality of service, a synchronization of the clocks or clock generators of both network technologies may still be necessary before the data transmission. In this context, the possibility exists to transfer the MOST time interval (for example 44.1 kHz or 48 kHz) as in-house clock generator into the AVB network and thus to clock the data streams. For this purpose, the MOST time interval can be derived from the MOST network and then transmitted into the Ethernet network by an AVB transport protocol.

By accurate time synchronization (e.g. by using IEEE802.1AS) of the Ethernet nodes with one another and thus also the gateways, it is possible to recover a time interval synchronous with MOST timing in the Ethernet network or in the receiver node that has a jitter of less than 1 μs.

Naturally, it is not necessary to synchronize the system clocks of both networks with one another, which can cause great expenditure. By the method, only an application clock is transported. This can be provided for the Ethernet network or the receiver node and can be used for synchronously transmitting data to the MOST network. Furthermore, it is completely up to the Ethernet network to generate its own time interval. The two systems can operate independently of one another.

According to one embodiment of the invention, the time stamp and the associated frequency of the data transmission with which a free-running data package is provided comprises a time interval of the clocked data package, the data being packaged into the free-running data package. In other words, the value of the time interval or the time of the time interval can be coded directly into the free-running data package. For example, it is possible that the transport protocol implemented in the gateway digitizes the MOST clock at the gateway and the MOST clock is recovered from this at the receiver node.

According to one embodiment of the invention, the method also comprises: collecting a number of clocked data packages; packaging the data of the collected data packages in a free-running data package. It is not necessary that precisely one clocked data package is allocated to each free-running data package. Since the transport volume of the free-running data communication network can be greater than that of the data communication network, the data of a number of data packages from the clocked data communication network can be transmitted simultaneously via the free-running data communication network.

According to one embodiment of the invention, the method also comprises: receiving the second free-running data packages in the gateway; creating clocked data packages from data of the second free-running data packages; feeding the clocked data packages into the clocked data communication network in time intervals which are synchronous with the time interval with which the second free-running data packages were generated in the receiver node. Using the method, it is possible that the data sent out by the receiver node is fed into the clocked data communication network synchronously with the sending out without these data having to be temporarily stored and/or the data packages having to be recoded in a complicated manner.

According to one embodiment of the invention, data transported by the data packages are part of a stream of media data, for example of audio and/or video data. The reconstructed time interval can then be used for clocking the reproduction of audio and/or video streams. Furthermore, this time interval can be used for clocking audio and/or video streams of an Ethernet device (i.e. of a device connected to the Ethernet node) and/or feeding them into the Ethernet network synchronously with the MOST clocking.

According to one embodiment of the invention, the gateway and/or receiver node comprises a Codec that generates and/or analog-to-digital-converts, and conversely, (free-running and/or clocked) data packages of a stream of media data synchronously with the time interval of the clocked data communication network. In the receiver node, the analog media stream can be generated by a Codec with the aid of the reconstructed time interval from the digital media stream. It is also possible that the gateway comprises a Codec that generates from the received free-running data packages clocked data packages that can be fed in synchronously with the time interval without intermediate storage.

A further aspect of the invention relates to a data communication system for a vehicle, for example a passenger vehicle, truck or bus.

According to one embodiment of the invention, the data communication system comprises a gateway for linking a clocked data communication network and a free-running data communication network and a receiver node in the free-running data communication network, the gateway and the receiver node being designed to perform the method as described above and below.

Naturally, features of the method as described above and below can also be features of the data communication system and conversely.

### BRIEF DESCRIPTION OF THE FIGURES:

In the text which follows, exemplary embodiments of the invention will be described in detail with reference to the attached figures.

FIG. 1 is a data communication system according to one embodiment of the invention;

FIG. 2 is a diagram of a method for synchronizing data packages according to one embodiment of the invention;

FIG. 3 is a data communication system according to one embodiment of the invention;

FIG. 4 is a diagram of a method for synchronizing data packages according to one embodiment of the invention.

In principle, identical or similar parts are provided with the same reference symbols.

### DETAILED DESCRIPTION OF EXEMPLARY EMBODIMENTS

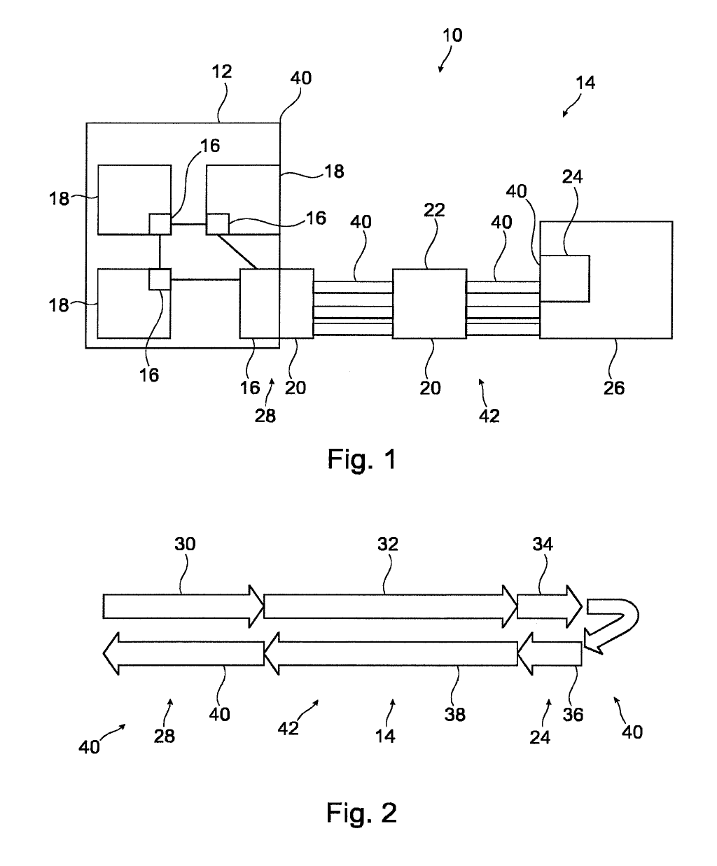

FIG. 1 is a data communication system 10 that comprises a MOST network 12 as clocked data communication network 12 and an Ethernet network 14 as free-running data communication network 14.

The MOST network 12, which has the topology of a ring, is operated with a MOST time interval, i.e. at each regular point in time specified by the MOST time interval, data packages are sent out between the MOST nodes 16 that can be in each case a component of a vehicle control device 18.

The Ethernet network 14 comprises a number of nodes 20 which, for example, can comprise a switch 22 or an Ethernet interface 24 of a vehicle control device 26.

The two networks 12, 14 are connected by a gateway 28 which comprises both a MOST node 16 and an Ethernet node 20, for example in the form of a switch.

The MOST ring 12 is characterized by a temporal synchronism with a clock rate of 44.1 kHz (audio clock rate of a CD) or 48 kHz (clock rate of a DVD audio). In the case of MOST, this clock is provided by a time interval master and all subscribers to the MOST network 12 become synchronized to this clock, i.e. they all operate synchronously with this master clock. The possibility exists, therefore, to set up synchronous data streaming between source and sink, for example between two of the control devices 18. For example, the gateway 28 can be the master which provides the master clock.

If data streaming is to be performed from the control device 26 to one of the control devices 18, problems of synchronism may occur. Although the control device 26 is able to generate an operating clock of, for example, 44.1 kHz (e.g. by oscillator circuits etc.), the clock, as a rule, does not have to be temporally synchronous with the MOST network 12, i.e. there can be deviations between this clock and the MOST network clock (for example MOST: 44.101 kHz, control device 44.099 kHz). If data streaming is performed from control device 26 to one of the control devices 18, it is necessary to match clock rates in the gateway 28. This can be done, for example, by inserting or omitting audio data or by an elaborate conversion of the clock rates. Both methods have effects on the audio quality and/or generate additional costs for the gateway 28. These problems can be bypassed with a method as is described, for instance, with reference to FIG. 2.

FIG. 2 shows a diagram for synchronizing data packages.

In step 30, gateway 28 receives MOST data packages from the clocked MOST network 12 that arrive in each case at times defined by the MOST clock. The MOST data packages can be based, for example, on a first audio or video data stream.

Gateway 28 then packages the data from the clocked data packages into Ethernet data packages and provides these with a time stamp from which the time can be reconstructed at which the respective MOST data package has arrived at gateway 28.

In step 32, the Ethernet data packages are sent to the receiver node 24 via the Ethernet network 14. The MOST clock coded in the Ethernet data packages is then transported via the Ethernet network 14.

In step 34, the receiver node reads the time stamps from the Ethernet data packages together with the transmitting frequency of the Ethernet data, the number of packages received and the local clock and from these data reconstructs the MOST clock of the MOST network 12, for example by the time stamps, the transmitting frequency and/or the number of packages. In this manner, the MOST clock can be recovered in the control device 26 or in the receiving node 24, respectively.

In step 36, the Ethernet node 24 generates Ethernet data packages which, for example, are based on a further, second audio or video data stream which, for example, is sent by the control device 26 to a control device 18 which is connected to the MOST network 12. These second Ethernet data packages are provided with a time stamp based on the reconstructed MOST clock.

In step 38, the second Ethernet data packages are sent out synchronously on the basis of a time interval synchronous with the reconstructed MOST clock. In this manner, the second Ethernet data packages are sent out with a derived time interval which is synchronous with the MOST clock.

In step 40, gateway 38 receives the second Ethernet data packages and recovers the time interval of these data packages on the basis of their time stamp, transmitting rate, number of packages and/or the aid of its local clock. The data contained in the second Ethernet data packages can be fed into the MOST network 12 synchronously with the MOST clock of the MOST network 12 without temporary storage.

In summary, FIG. 2 illustrates the transportation of the MOST clock into node 24 of the Ethernet network 14. The MOST clock can be restored there and used there for synchronizing other applications. Thus, the data communication system 10 can be divided into a MOST clock domain 40 and an Ethernet clock domain 42. The MOST clock domain 40 then extends virtually over the MOST network 12 into the receiving node 24.

If, as described above, the time interval of the MOST network 12 is transmitted to the control device 28 via the gateway 28 and the control device 28 uses this time interval for generating the data streaming, the source (receiving node 24 or control device 28, respectively) operates with the same time interval as the sink or parts of the sink (control device 18). It is possible, therefore, to introduce the data streaming of the control device 28, without using mechanisms such as inserting or omitting audio data or a clock rate conversion, via the gateway 28 into the time-controlled MOST network 12 and sending it to the sink.

The protocols used in this context in the Ethernet network 14 are, for example, IEEE802.1AS in combination with IEEE1722 for synchronizing the clock rates (of the time generators of the gateways and of node 24) and IEEE1722 for transmitting the data.

The Ethernet data packages can be transmitted by the IEEE1722 protocol which has a fixed transmitting cycle. Audio data are typically transmitted in a regular 8-kHz cycle. These fixed transmitting cycles allow the data transport to be planned.

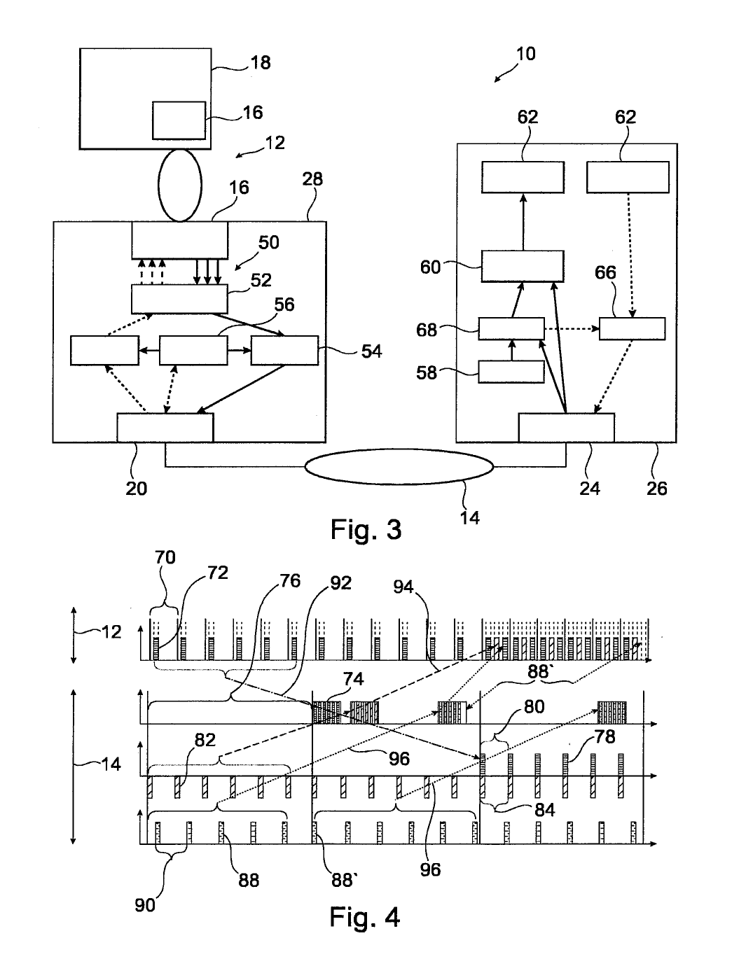

FIG. 3 shows parts of the data communication system 10 in greater detail. These statements on audio data made in the text which follows also apply to video data or streamed data in general.

The MOST clock (e.g. 48 kHz) and the uncompressed audio data are transmitted via the I2S bus 50 of the MOST node 16 or MOST controller 16, respectively, to the A/V Codec 52 of gateway 28. In this context, the MOST controller 16 of gateway 28, as I2S master, specifies the time interval of the A/V Codec 52 and thus clocks it, finally.

The audio data are packaged into IEEE1722 data packages by a packageizer 54 and sent out with the aid of an Ethernet clock generator (which is based on a system clock generator 56) synchronously to the I2S bus 50 via the Ethernet interface 20.

The control device 26 receives this data and regenerates the time interval of the audio data. For this purpose, the system clock generator 58 of the control device 26 (which has been synchronized previously with gateway 28) and the data from the audio stream are used. Finally, the audio data can also be provided analogously to an application 62 via the DAC (digital-to-analog) converter and reproduced synchronously with the MOST clock.

The regenerated or reconstructed time interval can now be used for triggering audio data which are output by the control device 26. These data, in turn, can be transmitted back to the gateway 28 and fed into the MOST network 12.

In this context, an application 64 generates analog audio data packaged by an audio Codec 66 into data packages which are sent to the gateway 28 by the Ethernet interface 24. Packaging and sending out the data packages is controlled by a clock generator module 68 which has reconstructed and restored the MOST clock from the data packages by the data from the MOST network 12.

The clock generator module 68 thus provides the Ethernet data packages with a derived MOST clock.

The Ethernet data packages are received in the Ethernet interface in gateway 28 and processed into MOST data packages (for example by means of an IC Codec 52) by the derived MOST clock coded into the Ethernet data packages, and fed into the MOST network 12. A clock generator module 70 then evaluates the Ethernet data packages in order to determine the derived MOST clock and to control the IC Codec.

It is to be understood that the MOST clock transmitted into the Ethernet network 14 can be called “House Clock” and is available to the audio systems and video systems within the Ethernet network 14 as driver of data processing and data transmission. In contrast, a “Sample Clock” can identify the sample rate which is used for converting an analog signal into the digital signal in Codec 66 and also for restoring the analog signal in the DAC converter 60 after the digital transmission.

FIG. 4 shows a diagram with data packages which can be sent out in the two networks 12 and 14. In the diagram of FIG. 4, the time is plotted towards the right.

In the first line of the diagram, the data packages 72 of the MOST network 12 are shown which are sent out to a MOST clock 70 in each case. The bus frequency or the time interval 70 and thus the transmitting rate of the MOST network 12 is 48 kHz. The clock of 48 kHz was selected for better representation and with regard to MOST 150.

The second line of the diagram shows data packages 74 of the Ethernet network 14. The clock frequency 76 of the IEEE1722 protocol is 8 kHz in the first version of the standard, i.e. exactly six times slower than the MOST clock 70. The data of six data packages 72 can thus be transmitted in a data package 74 in one IEEE1722 cycle.

The third line of the diagram shows reconstructed data packages 78 which are generated from the Ethernet data package 74 in the control device 26 and which, at the same time, supply a reconstructed time interval 80.

The fourth line of the diagram shows data packages 82 which have a derived time interval 84 which has been synchronized with the MOST clock 70 via the reconstructed time interval 80.

The fifth line of the diagram shows data packages 88 which have an asynchronous time interval 90 which has not been synchronized with the MOST clock 70.

FIG. 4 also shows three data streams 92, 94, 96 which can be analog audio streams and which will be explained in the text which follows.

In the first two lines, the data flow through the gateway 28 is shown. For the first data stream 92, the MOST data packages 72 are received by the gateway 28 and the data stream 92 is transmitted by the IEEE1722 transport protocol into the Ethernet network 14 in a manner as explained further above, up to the control device 26. This data stream 72 is thus transmitted by the Ethernet network 14 by means of QoS guarantees (which are provided by AVB).

The control device 26 restores the time interval 70 of the MOST network 12 and thus generates the reconstructed time interval 80 by which the DAC converter 60 is operated in order to restore the data stream 92. The data stream 92 restored in the control device 26 is now synchronous with the original MOST clock 70. Due to the processing and conversion in gateway 28, data packages 78 are delayed in comparison with data packages 72.

The time interval 80 can now be used in the control device 26 as “House Clock” already mentioned, in order to derive from it a time interval 84 by which the generating of the data stream 94 is controlled. The data stream 94 is then synchronous to the data stream 92 and thus also synchronous to the MOST clock 70.

The data stream 94 can now be transmitted to the gateway 28 and, after regeneration of its time interval, fed synchronously into the MOST network 12. Its synchronism with the MOST clock 70 thus guarantees maintenance of the quality. No sample rate converters or additional storage buffers are necessary in the gateway 28.

The data stream 96 is shown as an example of a data stream that is not synchronous with the “House Clock” and thus with the MOST clock 70. The frequency 90 of the data stream 96 is almost 48 kHz, for example 47.9 kHz. Analogously to data stream 95, the data stream 96 is packaged in IEEE1722 data packages and transmitted to the gateway 28 by the Ethernet network 14. Since the data stream 96 is not synchronous with the time interval 70 and thus the transmitting frequency of the IEEE1722 protocol, only five data packages 88 can be partially collected and sent out in the cycle of 8 kHz (125 μs). Thus, a data package 88′ is lost (in time), as is shown by way of an example. If the data stream 96 is an audio stream, this effect becomes distinctly audible during the reproduction of the data stream 96 in the MOST network 12 since the audio stream stops. In the case shown, the frequency of the data stream 96 is lower than that of the MOST network 70. In the reverse case, the MOST network 12 would have to discard data packages 88 which would also lead to similarly audible effects.

Additionally, it must be pointed out that “comprising” does not exclude any other elements or steps and “a” or “an” does not exclude a multiplicity. It should also be pointed out that features or steps which have been described with reference to one of the above exemplary embodiments can also be used in combination with other features or steps of other exemplary embodiments described above. Reference symbols in the claims should not be considered to be a restriction.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A method for synchronizing data packages from a free running data communication network with a clocked data communication network, comprising:
receiving clocked data packages from the clocked data communication network in a gateway at time intervals of the clocked data communication network;
packaging data from the clocked data packages into first free running data packages for the free running data communication network in the gateway;
providing the free running data packages with a time stamp from which a time interval of the clocked data packages, the data of which was packaged into a respective first free running data package, can be reconstructed;
sending the first free running data packages via the free running data communication network to a receiver node of the free running data communication network;
reading a respective time stamp from the first free running data packages;
reconstructing the time interval of the clocked data communication network from at least one of time stamps, a transmitting cycle, a number of clocked data packages, and a local clock in the receiver node; and
sending second free running data packages in a time interval which is synchronous with the reconstructed time interval.

12. The method as claimed in claim 11, further comprising:
synchronizing a clock generator of the gateway and a clock generator of the receiver node via the free running data communication network.

13. The method as claimed in claim 12, wherein the time stamp with which the free running data packages are provided are synchronous with a time interval of the clocked data packages, the data of which was packaged into a free running data package.

14. The method as claimed claim 11, further comprising:
collecting a number of clocked data packages;
packaging the data of the collected data packages in a respective free running data package.

15. The method as claimed in claim 11, further comprising:
receiving the second free running data packages in the gateway;
creating clocked data packages from data of the second free running data packages;
feeding the clocked data packages into the clocked data communication network in time intervals that are synchronous with the time interval with which the second free running data packages were generated in the receiver node.

16. The method as claimed in claim 11, wherein data transported by the data packages are part of a stream of media data.

17. The method as claimed in claim 16, wherein at least one of the gateway and the receiver node comprises a Codec that generates the data packages of the stream of the media data synchronously with the time interval of the clocked data communication network.

18. The method as claimed in claim 11, wherein the clocked data communication network is a MOST network.

19. The method as claimed in claim 11, wherein the free running data communication network is an Ethernet network.

20. A data communication system for a vehicle, comprising:
a gateway for linking a clocked data communication network and a free running data communication network;
a receiver node in the free running data communication network;
wherein the gateway and the receiver node are configured to:
receiving clocked data packages from the clocked data communication network in a gateway at time intervals of the clocked data communication network;
packaging data from the clocked data packages into first free running data packages for the free running data communication network in the gateway;
providing the free running data packages with a one time stamp from which a time interval of the clocked data packages, the data of which was packaged into a respective first free running data package, can be reconstructed;
sending the first free running data packages via the free running data communication network to a receiver node of the free running data communication network;
reading a respective time stamp from the first free running data packages and reconstructing the time interval of the clocked data communication network from at least one of the time stamps, a transmitting cycle, a number of clocked data packages, and a local clock in the receiver node; and
sending second free running data packages in a time interval which is synchronous with the reconstructed time interval.
